(19) United States
(12) Patent Application Publication
(10) Pub. No.: US 2003/0142762 A1
(43) Pub. Date: Jul. 31, 2003

(54) Wireless receiver method and apparatus using space-cover-time equalization

(76) Inventor: Joseph P. Burke, Carlsbad, CA (US)

Correspondence Address: Sarah Kirkpatrick, Manager, Intellectual Property Administration, QUALCOMM Incorporated, 5775 Morehouse Drive, San Diego, CA, 92121-1714, US

(21) Appl. No.: 10/044,523

(22) Filed: Jan. 11, 2002

(51) Int. Cl. H04L 27/06

(52) U.S. Cl. 375/340

(57) ABSTRACT

A receiver method and apparatus for performing equalization in the cover domain are disclosed. A receiver includes a cover equalizer that minimizes co-channel interference (CCI) between signals transmitted using different covers. The receiver includes at least one recorrelator which recorrelates received samples using a non-reference cover and a reference cover, producing recorrelated samples. After recorrelation, signals received from the non-reference transmitter can be treated in much the same way as a multipath signal received from the reference transmitter, or as a signal received through another receive antenna from the first transmitter. Such signals can be weighted in a weight generator using any of a variety of combining methods. Other types of equalization, for example in the time domain or in the space domain, may be performed before, after, or in conjunction with cover equalization.

### BACKGROUND

1. Field

The present invention relates generally to wireless communication, and more specifically to an improved method and apparatus for receiving wireless signals at a mobile station during soft handoff. Soft handoff refers to the transmission of a single data signal to a wireless receiver from multiple transmitters. Soft handoff has been described in many wireless communication standards and patents, especially with regard to CDMA systems, and is well known in the art.

2. Background

Wireless communication carriers desire more Forward Link (FL) capacity. For example, wireless communication carriers operating systems using a code-division multiple-access (CDMA) system such as TIA/EIA-95B (referred to herein as “IS-95”) or cdma2000 desire to maximize the capacity of their systems. One proposed approach to maximizing capacity involves using signal processing methods and more complex receivers to increase FL capacity to mitigate the effects of self-interference induced by multipath signals and frequency selective channels. For example, such multipath interference may be mitigated using space-time (S-T) equalization.

Though S-T equalization can be used to combat multipath signals received from a single transmitter, an S-T equalizer is non-optimal for receiving signals from multiple transmitters. For example, in a CDMA system, the receiver may be a mobile station that receives forward link signals from one or more base stations. When the receiver is not in handoff, multipath interference can dominate the interference seen by a user, making a RAKE receiver sub-optimal as compared to a equalizer that treats the arriving multipath signals as inter-chip-interference (ICI) with the goal of equalizing the channel. When multiple antennas are employed in the receiver, the equalizer takes the form of a S-T equalizer. The S-T equalizer outperforms the multi-antenna RAKE receiver where a frequency selective channel is present such that received multipath signals have large power relative to background noise. However, a S-T equalizer is not optimal for a mobile station in soft handoff.

In soft handoff, multiple base stations may transmit data to a mobile station using different pseudonoise (PN) code offsets or Walsh code covers. The typical S-T equalizer can equalize for the arrival of delayed copies of a single signal, but not for signals received with different PN offsets and Walsh code covers. An S-T engine sees signals from different transmitters as co-channel interference (CCI) due to different PN and Walsh covers. There is therefore a need in the art for a receiver having performance that approaches that of a S-T receiver when receiving signals from multiple transmitters.

### SUMMARY

The word “exemplary” is used herein to mean “serving as an example, instance, or illustration.” Any embodiment described herein as “exemplary” is not necessarily to be construed as preferred or advantageous over other embodiments.

Embodiments disclosed herein address the above stated needs by enabling a receive equalizer to mitigate mutual interference from signals received from different transmitters using different covers. As used herein, a cover can be any mixing or multiplier signal used by a receiver in soft handoff to distinguish the transmissions of different base stations. For example, in a CDMA system, different sectors may transmit signals using different pilot PN covers in order to un-correlate signals from sector to sector. In addition, it has been proposed to cover the multiple transmit antennas of a single sector using different covers. The embodiments described may be equally applied to such multiple-transmit-antenna transmitters. Different pilot PN covers can be generated by using different generator polynomials or by time-offsetting a single PN sequence, as is commonly done in an IS-95 CDMA system. Also, data signals received from different transmitters may be spread by codes other than PN codes, such as different orthogonal Walsh codes. As used herein, a cover be can any of the above mixing signals or any combination thereof.

As described herein, a cover-type equalizer minimizes co-channel interference (CCI) between signals transmitted using different covers by recorrelating those signals. A cover-type equalizer may combine cover equalization with other forms of equalization such as space-equalization or time-equalization to optimally minimize such co-channel interference. In an exemplary aspect, recorrelation is accomplished by de-covering and re-covering a first signal received from a first transmitter such that the signal is recorrelated with a second signal received from a second transmitter. The de-covering may be accomplished by mixing the first signal with the cover used by the first transmitter. The resulting de-covered first signal is then re-covered by mixing that signal with the cover used by the second transmitter. After recorrelation, the various received signals can be treated in much the same way as a multipath signal received from the first transmitter, or as a signal received through another receive antenna from the first transmitter, making subsequent types of equalization possible. Combining in the cover domain can then be carried out in much the same way as space-only combining or space-time equalization. The recorrelated composite signal can then be equalized using S-C-T equalization.

An equalizer may also utilize a subset of the full S-C-T approach described herein. For example, where a receiver in soft handoff has only one receive antenna, the receiver may instead employ a cover-time (C-T) equalizer to improve performance.

A single receiver may also use multiple subsets of S-C-T equalization concurrently. For example, a receiver may receive a combination of soft-handoff and non-soft-handoff signals. For example, a single receiver might receive a first signal from multiple base stations, such as an IS-95 or cdma2000 signal, and simultaneously a high-data-rate signal from a single base station, as described in EIA/TIA IS-856. Such a receiver may employ S-C-T equalization for the first signal and S-T equalization for the high-data-rate signal.

### BRIEF DESCRIPTION OF THE DRAWINGS

FIG. 1 is a is a generalized block diagram of a space-cover-time (S-C-T) equalization process;

FIG. 2 is a flowchart of an exemplary S-C-T equalization method;

FIG. 3 is a block diagram of a receiver that utilizes S-C-T equalization;

FIG. 4 is a diagram of a PN recorrelator and a Walsh recorrelator; and

FIG. 5 is a diagram of a S-C-T receiver utilizing S-T equalizers.

### DETAILED DESCRIPTION

By performing equalization in the cover dimension, an S-C-T equalizer expands the S-T mathematical basis. A noted difference between the cover domain and the space domain is that in the cover domain, the interference can be un-correlated from cover to cover (different interference PN covers). Different embodiments of the general S-C-T equalizer include a maximal ratio combining (MRC) cover combiner followed by an S-T equalizer. Alternatively, the equalizer may include an MRC cover combiner, or minimum mean square error (MMSE) space combiner followed by a time equalizer.

A RAKE receiver is an example of a time equalizer. It is a well-known property of CDMA signals that multiple multipath instances of the same signal at different time offsets are largely uncorrelated with each other. However, by shifting various copies of the received signal, a RAKE receiver realigns the multipath signals so that they become once again correlated. After such realignment, the multipath copies of the received signal may be added together before decoding. In a CDMA system that employs an orthogonal pilot signal, a RAKE receiver can coherently combine the forward link signals arriving at varying time offsets.

In the following paragraphs, the solution for the general least squares (LS) derivation of the S-C-T equalizer is presented, followed by exemplary embodiments of cover-domain recorrelating equalizing receivers.

I. Forward Link Matrix Model

For purposes of analysis, we assume a multi-sector forward link cell environment, per sector frequency selective fading channel model, perfect average power control, and perfect estimates of all parameters. One skilled in the art will recognize that the described embodiments will still operate using average power control and parameter estimates that are less than perfect. We model the time resolvable multipath of the user on a power and time delay basis and assume each multipath is fading and distributed in time un-correlated with other multipath.

We specify the discrete time index n=1:N and model our desired user with signal s₀(t) having known pilot PN sequence

$${{p}_{u}}_{1 \times N}$$

for sector u and known data Walsh cover

$${{q}_{v}}_{1 \times N}$$

with Walsh index v. We model the per sector equivalent M antenna by N time channel state matrix as

$${{H}_{u}}_{M \times N}$$

(convolution of PN sequence and channel for sector u), and the complex Gaussian M antenna by N time mobile station additive receiver noise matrix as

$${B}_{M \times N} .$$

As discussed herein, M is the number of receive antennas and N is the sampling period over which the channel is expected to remain substantially constant. The period N is generally between one and ten milliseconds, depending on expected Doppler variability of the received signal.

We use a base sector PN sequence,

$${{p}_{0}}_{1 \times N} ,$$

as our desired reference signal and seek to find the best linear weight solution,

$${W}_{M \times U \times {T}_{2}} ,$$

solution that minimizes the least square (LS) error between the output sequence,

$${{\hat{p}}_{0}}_{1 \times N} ,$$

and the input sequence

$${{p}_{0}}_{1 \times N} .$$

We note this LS solution approaches the MMSE solution as the time index N increases to where sufficient estimates of the second order statistics are obtained (ergodicity). Realizable mobile stations have finite noise power and hence the W matrix that will maximize the received signal carrier to interference plus noise ratio (CINR) is one that will trade-off non-perfect equalization relative to the mobile stations background noise.

We defined X as the combination of the channel state matrix H_{U} for all U sectors plus the receiver conversion background noise matrix, B:

$$X = {\sum }_{u = 0}^{U - 1} {H}_{u} + B \qquad EQN . ( 1 )$$

We illustrate X from in matrix form as:

$${X}_{M \times N} = [ \begin{matrix}{{x}^{->}}_{1} & {{x}^{->}}_{2} & ⋯ & {{x}^{->}}_{N}\end{matrix} ] = [ \begin{matrix}{x}_{1 , 1} & {x}_{1 , 2} & … & {x}_{1 , N} \\ {x}_{2 , 1} & {x}_{2 , 2} & … & {x}_{2 , N} \\ ⋮ & ⋮ & ⋰ & ⋮ \\ {x}_{M , 1} & {x}_{M , 2} & … & {x}_{M , N}\end{matrix} ] \qquad EQN . ( 2 )$$

where \vec{x}ₙ is a vector of all equivalent antenna samples for time index n. We redefine X as X to support matrix convolutions in determining a time dependent weight matrix with T₂ taps:

$$\begin{matrix}{X}_{M {T}_{2} \times N} = [ \begin{matrix}{X [ 1 - ( {T}_{2} - 1 ) / 2 ]}_{M \times N} \\ ⋮ \\ {X [ 1 ]}_{M \times N} \\ ⋮ \\ {X [ 1 + ( {T}_{2} - 1 ) / 2 ]}_{M \times N}\end{matrix} ] \\ = [ \begin{matrix}{{x}^{->}}_{1 - \frac{{T}_{2} - 1}{2}} & {{x}^{->}}_{2 - \frac{{T}_{2} - 1}{2}} & … & {{x}^{->}}_{N - 1 - \frac{{T}_{2} - 1}{2}} & {{x}^{->}}_{N - \frac{{T}_{2} - 1}{2}} \\ ⋮ & ⋮ & … & ⋮ & ⋮ \\ {{x}^{->}}_{1} & {{x}^{->}}_{2} & … & {{x}^{->}}_{N - 1} & {{x}^{->}}_{N} \\ ⋮ & ⋮ & … & ⋮ & ⋮ \\ {{x}^{->}}_{1 + \frac{{T}_{2} - 1}{2}} & {{x}^{->}}_{2 + \frac{{T}_{2} - 1}{2}} & … & {{x}^{->}}_{N - 1 + \frac{{T}_{2} - 1}{2}} & {{x}^{->}}_{N + \frac{{T}_{2} - 1}{2}}\end{matrix} ]\end{matrix} \qquad EQN . ( 3 )$$

A typical S-T only weight matrix for sector u, W_{U}, for reference can be written as:

$${{W}_{u}}_{M \times {T}_{2}} = [ \begin{matrix}{{w}^{->}}_{1} & {{w}^{->}}_{2} & ⋯ & {{w}^{->}}_{{T}_{2}}\end{matrix} ] = [ \begin{matrix}{w}_{1 , 1} & {w}_{1 , 2} & … & {w}_{1 , {T}_{2}} \\ {w}_{2 , 1} & {w}_{2 , 2} & … & {w}_{2 , {T}_{2}} \\ ⋮ & ⋮ & ⋰ & ⋮ \\ {w}_{M , 1} & {w}_{M , 2} & … & {w}_{M , {T}_{2}}\end{matrix} ] \qquad EQN . ( 4 )$$

where can redefine W_{U} into wᵤ, a single column vector format for the u^{th} S-T weight solution:

$${{W}_{u}}_{M {T}_{2} \times 1} = [ \begin{matrix}{{w}^{->}}_{1} \\ {{w}^{->}}_{2} \\ ⋮ \\ {{w}^{->}}_{{T}_{2}}\end{matrix} ] \qquad EQN . ( 5 )$$

to aid in the matrix analysis of the convolution of W and X.

The u^{th} sector S-T only solution,

$${{\hat{p}}_{u}}_{1 \times N} = Tr ( {W}_{u}^{H} X ) = {W}_{u}^{H} X ,$$

fails to include the cover dimension and hence is sub-optimal where each sector is independently analyzed (with combining after de-cover).

II. Channel Model Details

The channel state matrix H is described in more detail in this section.

The relative time constants in the channel are assumed such that time delays between multipaths, τ₀−τ₁=1/B_{coh}, are smaller or occur less often than changes in channel vector coefficients, ΔT_{chan}=1/B_{Doppler}. That is, the Doppler bandwidth, B_{Doppler}, is much less than the Coherence bandwidth of the channel, B_{coh} or B_{coh}>>B_{Doppler}.

By definition of B_{coh}, we define the channel state matrix to be wide sense stationary (WSS) in discrete time notation up to time index N or in continuous time notation up to time duration ΔT_{chan}=1/B_{Doppler}. By definition of B_{Doppler}, we define the memory of the channel in discrete time notation is T₁, with T₁<N, or in continuous time notation is on the order of τ₀−τ₁=1/B_{coh}. Using these relations for relative time in the system, we proceed to define in more detail the channel impulse response and channel state matrix.

The continuous time low pass equivalent impulse response of the channel for sector u, h_{uM,L}(t,τ), has L independently fading ray paths or multipath signals from the BTS transmit antenna to the M mobile terminal receiving antennas. Each time resolvable multipath has un-correlated fading parameter \vec{c}. We specify the discrete time channel impulse response of the channel in an equivalent discrete time M antenna by T₁ time delay matrix,

$${{h}_{u} ( n )}_{M \times {T}_{1}} ,$$

where the time delay of each multipath corresponds to a specific column of h_{U}(n) (note h_{U}(n) has memory of length T₁):

$$\begin{matrix}{h}_{uM , L} ( t , τ ) = {\sum }_{l = 0}^{L - 1} {{c}^{->}}_{u , l} δ ( t - {τ}_{u , l} ) {⟶}^{DT} {{h}_{u} ( n )}_{M \times {T}_{1}} \\ = [ \begin{matrix}{{c}^{->}}_{u , 0} & 0 & ⋯ & 0 & {{c}^{->}}_{u , 1} & 0 & ⋯ & 0 & {{c}^{->}}_{u , L - 1}\end{matrix} ]\end{matrix} \qquad EQN . ( 6 )$$

Exciting or convolving the channel impulse response,

$${{h}_{u} ( n )}_{M \times {T}_{1}} ,$$

for sector u with the corresponding u^{th} sector reference (PN) waveform,

$${{p}_{u}}_{1 \times N} ,$$

yields the equivalent M antenna by N channel state matrix for sector u, i.e.

$$s ( n ) \cdot {{p}_{u}^{*}}_{1 \times N} {h}_{u} {( n )}_{M \times {T}_{1}} = {{H}_{u}}_{M \times N} .$$

III. De-Cover and Re-Cover Process to Separate Sectors

The different PN and Walsh covers in EQN. (1) make difficult a typical S-T equalizer as the signal from different sectors are un-correlated with one another, i.e. can't use signals from other sectors to help equalizer signals in desired sector. Currently, a typical MS in handoff would de-cover each sector waveform, to remove the un-correlated nature of the PN cover, and then combine the now correlated signals in a RAKE receiver type structure. In the proposed S-C-T receiver go a step further, we first de-cover other sectors but then also re-cover the same other sectors with a base desired PN and Walsh cover to allow full equalization, in chip time, using signals from all sectors.

We define in matrix form, to simplify matrix manipulation, the PN cover for sector u as the N×N diagonal matrix P_{U}:

$${{P}_{u}}_{N \times N} = [ \begin{matrix}{p}_{u} ( 1 ) & & & 0 \\ & {p}_{u} ( 2 ) & & \\ & & ⋰ & \\ 0 & & & {p}_{u} ( N )\end{matrix} ] \qquad EQN . ( 7 )$$

and for the sake of completeness the N×N Walsh cover matrix for Walsh cover v as the diagonal matrix Q_{V}:

$${{Q}_{v}}_{N \times N} = [ \begin{matrix}{q}_{v} ( 1 ) & & & 0 \\ & {q}_{v} ( 2 ) & & \\ & & ⋰ & \\ 0 & & & {q}_{v} ( N )\end{matrix} ] \qquad EQN . ( 8 )$$

We note that

$${{p}_{u}}_{1 \times N} = {1}_{1 \times N} \cdot {{P}_{u}}_{N \times N} .$$

We describe

$${Y}_{M \times u \times N}$$

as the on-time de-covered/recovered waveform for sector u assuming sector 0 is the base sector, derived from the on-time received data and noise matrix X in EQN. (2), as:

$${Y}_{M \times u \times N} = {X}_{M \times N} \cdot {{G}_{u}}_{N \times N} \cdot {{G}_{0}}_{N \times N} \qquad EQN . \text{(9a)}$$

where G_{U} is the generalized de-cover/re-cover matrix. Note that when Gᵤ=Pᵤ we only de-cover/re-cover the PN for sector u. When we specifically de-cover/re-cover the PN and Walsh code for sector u using a different Walsh cover indexes, Gᵤ=Pᵤ·Qᵥ, we illustrate the different Walsh index via modification to (9a) as:

$${{Y}_{v}}_{M \times u \times N} = {X}_{M \times N} \cdot {{G}_{u}}_{N \times N} \cdot {{G}_{0}}_{N \times N} \qquad EQN . \text{(9b)}$$

We describe

$${Y}_{M \times U \times N} ,$$

in general, as a M×U×N matrix where each sectors de-covered/recovered waveform is u^{th} matrix in the u=0:U−1 dimension:

$${Y}_{M \times U \times N} = [ \begin{matrix}{Y}_{M \times 0 \times N} = {X}_{M \times N} \\ {Y}_{M \times 1 \times N} \\ ⋮ \\ {Y}_{M \times U - 1 \times N}\end{matrix} ] \qquad EQN . ( 10 )$$

Obtaining a time dependent equalizer, i.e. the S-C-T or the C-T, we need to multiply the early/late received waveform X as described in EQN. (3) with G in a manner described in EQN. (9) to obtain the u^{th} time dependent de-covered/recovered waveform,

$${Y ( u )}_{{MuT}_{2} \times N} ,$$

where:

$$\begin{matrix}\begin{matrix}{Y ( u )}_{M u {T}_{2} \times N} = {X}_{M {T}_{2} \times N} \cdot {{G}_{u}}_{N \times N} \cdot {{G}_{0}}_{N \times N} \\ = [ \begin{matrix}{{x}^{->}}_{1 - \frac{{T}_{2} - 1}{2}} & {{x}^{->}}_{2 - \frac{{T}_{2} - 1}{2}} & … & {{x}^{->}}_{N - 1 - \frac{{T}_{2} - 1}{2}} & {{x}^{->}}_{N - \frac{{T}_{2} - 1}{2}} \\ ⋮ & ⋮ & … & ⋮ & ⋮ \\ {{x}^{->}}_{1} & {{x}^{->}}_{2} & … & {{x}^{->}}_{N - 1} & {{x}^{->}}_{N} \\ ⋮ & ⋮ & … & ⋮ & ⋮ \\ {{x}^{->}}_{1 + \frac{{T}_{2} - 1}{2}} & {{x}^{->}}_{2 + \frac{{T}_{2} - 1}{2}} & … & {{x}^{->}}_{N - 1 + \frac{{T}_{2} - 1}{2}} & {{x}^{->}}_{N + \frac{{T}_{2} - 1}{2}}\end{matrix} ] \cdot \\ {{G}_{u}}_{N \times N} \cdot {{G}_{0}}_{N \times N}\end{matrix} & EQN . ( \text{11a} ) \\ \begin{matrix}{Y ( u )}_{M u {T}_{2} \times N} = {X}_{M {T}_{2} \times N} \cdot {{G}_{u}}_{N \times N} \cdot {{G}_{0}}_{N \times N} \\ = [ \begin{matrix}{{y}^{->}}_{u , 1 - \frac{{T}_{2} - 1}{2}} & {{y}^{->}}_{u , 2 - \frac{{T}_{2} - 1}{2}} & … & {{y}^{->}}_{u , N - 1 - \frac{{T}_{2} - 1}{2}} & {{y}^{->}}_{u , N - \frac{{T}_{2} - 1}{2}} \\ ⋮ & ⋮ & … & ⋮ & ⋮ \\ {{y}^{->}}_{u , 1} & {{y}^{->}}_{u , 2} & … & {{y}^{->}}_{u , N - 1} & {{y}^{->}}_{u , N} \\ ⋮ & ⋮ & … & ⋮ & ⋮ \\ {{y}^{->}}_{u , 1 + \frac{{T}_{2} - 1}{2}} & {{y}^{->}}_{u , 2 + \frac{{T}_{2} - 1}{2}} & … & {{y}^{->}}_{u , N - 1 + \frac{{T}_{2} - 1}{2}} & {{y}^{->}}_{u , N + \frac{{T}_{2} - 1}{2}}\end{matrix} ]\end{matrix} & EQN . ( \text{11b} )\end{matrix}$$

We use the time dependent de-covered/recovered

$${Y ( u )}_{{MuT}_{2} \times N}$$

matrices to form

$${Y}_{{MUT}_{2} \times N} ,$$

in general, for u=0:U−1 (U way handoff) to support matrix convolutions in determining a S-C-T weight matrix with T₂ time taps, as:

$${Y}_{{MUT}_{2} \times N} = [ \begin{matrix}{\vec{y}}_{0 , 1 - \frac{{T}_{2} - 1}{2}} & {\vec{y}}_{0 , 2 - \frac{{T}_{2} - 1}{2}} & ⋯ & {\vec{y}}_{0 , N - 1 - \frac{{T}_{2} - 1}{2}} & {\vec{y}}_{0 , N - \frac{{T}_{2} - 1}{2}} \\ ⋮ & ⋮ & ⋯ & ⋮ & ⋮ \\ {\vec{y}}_{U - 1 , 1 - \frac{{T}_{2} - 1}{2}} & {\vec{y}}_{U - 1 , 2 - \frac{{T}_{2} - 1}{2}} & ⋯ & {\vec{y}}_{U - 1 , N - 1 - \frac{{T}_{2} - 1}{2}} & {\vec{y}}_{U - 1 , N - \frac{{T}_{2} - 1}{2}} \\ ⋮ & ⋮ & ⋯ & ⋮ & ⋮ \\ {\vec{y}}_{0 , 1} & {\vec{y}}_{0 , 2} & ⋯ & {\vec{y}}_{0 , N - 1} & {\vec{y}}_{0 , N} \\ ⋮ & ⋮ & ⋯ & ⋮ & ⋮ \\ {\vec{y}}_{U - 1 , 1} & {\vec{y}}_{U - 1 , 2} & ⋯ & {\vec{y}}_{U - 1 , N - 1} & {\vec{y}}_{U - 1 , N} \\ ⋮ & ⋮ & ⋯ & ⋮ & ⋮ \\ {\vec{y}}_{0 , 1 + \frac{{T}_{2} - 1}{2}} & {\vec{y}}_{0 , 2 + \frac{{T}_{2} - 1}{2}} & ⋯ & {\vec{y}}_{0 , N - 1 + \frac{{T}_{2} - 1}{2}} & {\vec{y}}_{0 , N + \frac{{T}_{2} - 1}{2}} \\ ⋮ & ⋮ & ⋯ & ⋮ & ⋮ \\ {\vec{y}}_{U - 1 , 1 + \frac{{T}_{2} - 1}{2}} & {\vec{y}}_{U - 1 , 2 + \frac{{T}_{2} - 1}{2}} & ⋯ & {\vec{y}}_{U - 1 , N - 1 + \frac{{T}_{2} - 1}{2}} & {\vec{y}}_{U - 1 , N + \frac{{T}_{2} - 1}{2}}\end{matrix} ] \qquad EQN . ( 12 )$$

In a similar manner to S-T processing via Projection operations into S-T estimation spaces, we later develop Projection operators that minimize a cost function in a Euclidean norm sense in the S-C-T estimation space of

$${Y}_{M \times U \times N} .$$

IV. General S-C-T Least Squares Equalizer

We seek to determine the multi-dimensional weight matrix, W, with tap length or a memory in time of T₂ where T₁≦T₂≦N (T₁ is the memory of the channel). The S-C-T weight matrix W is illustrated as:

$${W}_{M \times U \times {T}_{2}} = [ \begin{matrix}{\vec{W}}_{1 , 1} & {\vec{W}}_{1 , 2} & ⋯ & {\vec{W}}_{1 , {T}_{2}} \\ {\vec{W}}_{2 , 1} & {\vec{W}}_{2 , 2} & ⋯ & {\vec{W}}_{2 , {T}_{2}} \\ ⋮ & ⋮ & ⋰ & ⋮ \\ {\vec{W}}_{M , 1} & {\vec{W}}_{M , 2} & ⋯ & {\vec{W}}_{M , {T}_{2}}\end{matrix} ] \qquad EQN . ( 13 )$$

where \vec{w}_{m,i} is the U×1 weight vector (in cover dimension) for antenna m at relative time index i.

Redefining \vec{w}_{m,i} into a new M·U×1 vector \vec{w}ᵢ at relative time index i:

$${{\vec{w}}_{i}}_{M U \times 1} = [ \begin{matrix}{\vec{w}}_{0 , i} \\ {\vec{w}}_{1 , i} \\ ⋮ \\ {\vec{w}}_{M - 1 , i}\end{matrix} ] \qquad EQN . ( 14 )$$

we can re-write Win EQN. (13) into the S-C-T weight matrix,

$${W}_{{MUT}_{2} \times 1} ,$$

as:

$${W}_{M {UT}_{2} \times 1} = [ \begin{matrix}{\vec{w}}_{1} \\ {\vec{w}}_{2} \\ ⋮ \\ {\vec{w}}_{{T}_{2}}\end{matrix} ] \qquad EQN . ( 15 )$$

where

$${W}_{M \cdot U \cdot {T}_{2} \times 1}$$

is a single column vector format for all m=0:M−1 antennas, u=0:U−1 sectors, with temporal memory or relative time index i=0:T₂−1. We proceed to find the optimum

$${W}_{M U {T}_{2} \times 1} .$$

We define the error term, e, as the difference between the estimate of the desired user's reference signal, \hat{p}₀, and the desired users true reference signal p₀. The error term, e, is written in matrix notation over m=0:M−1 antennas, u=0:U−1 sectors, and n=1:N time samples.

We proceed to define the LS cost function using the orthogonality principle and further define/redefine in more detail the following terms:

$$Desired Response : {{p}_{0}}_{1 \times N} = [ \begin{matrix}{p}_{0} ( 1 ) & {p}_{0} ( 2 ) & … & {p}_{0} ( N )\end{matrix} ] \\ Estimate of Desired Response : {{\hat{p}}_{0}}_{1 \times N} = Tr ( {W}^{H} Y ) = {W}^{H} Y \\ Estimation Error : {e}_{1 \times N} = {p}_{0} - {\hat{p}}_{0} = {p}_{0} - {W}^{H} Y \qquad EQN . ( 16 )$$

where the coefficients of the ST weight are determined by minimizing the sum of the squared errors:

$$Error Energy \text{:} E = {\sum }_{n = 1}^{N} {\vert e ( n ) \vert}^{2} \qquad EQN . ( 17 )$$

The ST weight matrix is assumed to be held constant over time 1≦n≦N.

The on-time single sector estimation space, M-dimensional subspace, is the row space of the matrix X given a specified sector PN. Clearly, any estimate \hat{p}₀ for an on-time receive signal must lie in this M dimensional estimation space. The desired response p₀, in general, lies outside the estimation space.

In the S-C-T implementation, we have a MUT₂-dimensional row space of

$${Y}_{{MUT}_{2} \times N}$$

being the estimation space. The S-C-T estimation space is composed of the typical M dimensional on-time estimation space plus early/late-time subspaces for all U sectors.

We use the LS error criterion, i.e. notion that the squared length of e is a minimum when e is orthogonal to the estimation space, i.e.

$$e ⊥ {Y}_{1 \times N}$$

for 1≦i≦M·U·T₂ (orthogonality principle), and write the LS normal equations as:

$$e ⊥ {Y}_{i \times N} {\to }^{ for all i } {Y}_{M U \cdot {T}_{2} \times N} \cdot {{e}_{N \times 1}}^{H} = {0}_{M U {T}_{2} \times 1} \qquad EQN . ( 18 )$$

or in more detail as:

$${Y}_{M U {T}_{2} \times N} \cdot {{e}_{N \times 1}}^{H} = {Y}_{M U \cdot {T}_{2} \times N} \cdot [ {{p}_{0}^{H}}_{N \times 1} - {{Y}^{H}}_{N \times M U {T}_{2}} \cdot {W}_{M U {T}_{2} \times 1} ] = {0}_{M \cdot U {T}_{2} \times 1} {\to }^{ yields } Y \cdot {Y}^{H} \cdot W = Y \cdot {p}_{0}^{H} \qquad EQN . ( 19 )$$

Assuming that Y·Y^{H} is non-singular and invertible, we solve for the general LS error ST weight solution as:

$${W}_{{MUT}_{2} \times 1} = {( {Y}_{{MUT}_{2} \times N} \cdot {{Y}^{H}}_{N \times {MUT}_{2}} )}^{- 1} \cdot {Y}_{{MUT}_{2} \times N} \cdot {{p}_{0}^{H}}_{N \times 1} \qquad EQN . ( 20 )$$

Rather than computing an inverse matrix, other methods known in the art may be used for solving EQN. (19). For example, a solution to EQN. (19) might also be generated using the Moore-Penrose inverse computed using the singular value decomposition, Cholesky factorization, or QR factorization. We then solve for the estimate of the desired base PN sequence as:

$${{\hat{p}}_{0}}_{1 \times N} = {{W}^{H}}_{1 \times {MUT}_{2}} \cdot {Y}_{{MUT}_{2} \times N} = {{p}_{0}}_{1 \times N} \cdot {{{Y}^{H}}_{N \times {MUT}_{2}} ( {Y}_{{MUT}_{2} \times N} \cdot {{Y}^{H}}_{N \times {MUT}_{2}} )}^{- 1} \cdot {Y}_{{MUT}_{2} \times N} \qquad EQN . ( 21 )$$

We note the S-C-T solution \hat{p}₀ to be that of a desired signal projected onto the row space or estimation space of Y, as expected, via the projection operator:

$${{P}_{Y}}_{N \times N} = {{{Y}^{H}}_{N \times {MUT}_{2}} ( {Y}_{{MUT}_{2} \times N} \cdot {{Y}^{H}}_{N \times {MUT}_{2}} )}^{- 1} \cdot {Y}_{{MUT}_{2} \times N} \qquad EQN . ( 22 )$$

We solve for the estimate of the desired data symbol stream, ŝ₀(t), using the S-C-T weight in EQN. (20) and the modified version Yᵥ in EQN. (9b) that accounts for changes in Walsh covers, by de-covering the received data symbol stream with the base sector PN and Walsh cover as:

$$\begin{matrix}{{\hat{s}}_{0} ( t )}_{1 \times {N}_{1}} = \underbrace{[ {{W}^{H}}_{1 \times M U {T}_{2}} \cdot {{Y}_{v}}_{M U \cdot {T}_{2} \times {N}_{1}} ]}_{S - C - T Combined Output} \cdot \underbrace{{{P}_{0}}_{{N}_{1} \times {N}_{1}} \cdot {{Q}_{0}}_{{N}_{1} \times {N}_{1}}}_{De \text{-} cover PN / Walsh} = \\ [ {{p}_{0}}_{1 \times N} \cdot {{{Y}^{H}}_{N \times M U {T}_{2}} ( {Y}_{M U {T}_{2} \times N} \cdot {{Y}^{H}}_{N \times M U {T}_{2}} )}^{- 1} \cdot {{Y}_{v}}_{M U {T}_{2} \times {N}_{1}} ] \cdot {{P}_{0}}_{{N}_{1} \times {N}_{1}} \cdot {{Q}_{0}}_{{N}_{1} \times {N}_{1}}\end{matrix} \qquad EQN . ( 23 )$$

where we have introduced the time index, N₁, to allow for final data symbol de-covering time durations that are smaller than the time duration used in the weight calculation, N, where N₁≦N.

Note that EQN. (23) reflects a modified Projection operator due to the different Walsh covers in Yᵥ vs. Y when sectors in handoff use different Walsh covers. While EQN. (20) and EQN. (22) are optimized for the Pilot PN for the base sector, the modified Projection inherent in EQN. (23) is also expected to S-C-T equalize in a near optimum manner.

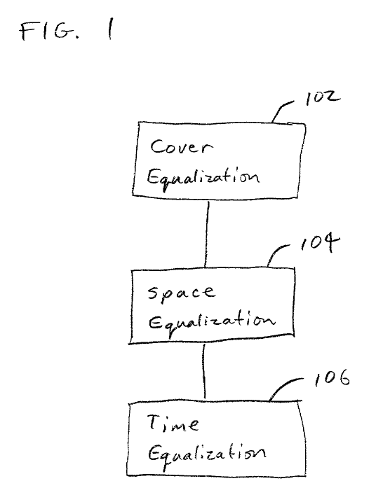

FIG. 1 is a generalized block diagram of space-cover-time (S-C-T) equalization. Block 102, represents equalization in the cover dimension, block 104 represents equalization in the space dimension, and block 106 represents equalization in the time dimension. Space-time (S-T) equalization is known in the art. In an exemplary embodiment, a receiver performs equalization in the cover domain in addition to equalization in the space and time domains to achieve space-cover-time (S-C-T) equalization. Cover equalization can also be performed separately or in combination with one of the other dimensions. For example, a receiver may employ cover-time (C-T) or space-cover (S-C) equalization. Additionally, a receiver may perform cover-only equalization followed by S-T equalization. An equalizer that performs cover equalization alone or performs cover equalization in conjunction with at least one other form of equalization is a cover equalizer.

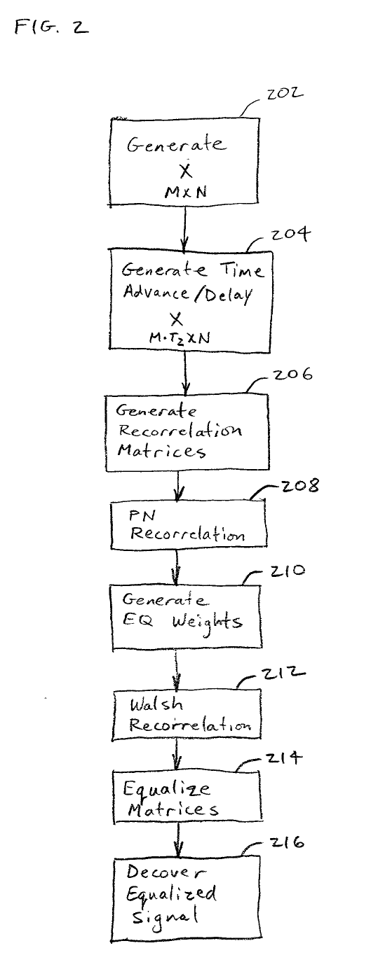

FIG. 2 is a flowchart of an exemplary S-C-T equalization method. At step 202, the received samples from each of M antennas are assembled into the M×N matrix X described in EQN. (1) and EQN. (2). At step 204, T₂ time-advanced and time-delayed versions of X are generated and assembled into a larger M·T_{2×}N matrix

$${X}_{M \cdot {T}_{2} \times N}$$

described in EQN. (3).

At step 206, recorrelation matrices are generated for use in recorrelating the signals within the various received sample matrices. In an exemplary embodiment that uses IS-95 or cdma2000 types of forward link signals, separate PN and Walsh recorrelation matrices are generated according to EQN. (7) and EQN. (8) for all transmitters other than a reference transmitter. At step 208, the PN recorrelation matrix is applied to the matrix

$${X}_{M \cdot {T}_{2} \times N}$$

as described in EQN. (9a), EQN. (9b) to generate PN-recorrelated matrices as described in EQN. (10) to EQN. (12).

At step 210, the matrix

$${X}_{M \cdot {T}_{2} \times N}$$

and the various PN-recorrelated matrices are used to generate equalization weights according to EQN. (13) to EQN. (20). In an exemplary embodiment, this is accomplished by minimizing the Euclidean distance between reference signals and estimating the reference signal using the principle of orthogonality (wherein the error signal is orthogonal to the estimation space). Other methods of generating, for example maximal ratio combining (MRC), may also be used. In an exemplary embodiment, an S-C-T weight matrix is generated using matrix inversion. As discussed above, EQN. (19) can be solved using a variety of approaches. For example, a solution to EQN. (19) might also be generated using the Moore-Penrose inverse computed using the singular value decomposition, Cholesky factorization, or QR factorization.

At step 212, the Walsh recorrelation matrices generated at step 206 are applied to the corresponding PN-recorrelated matrices generated in step 208. Specifically, where a PN-recorrelated matrix was generated using a PN recorrelation matrix corresponding to a particular non-reference transmitter, the Walsh recorrelation matrix corresponding to that particular non-reference transmitter is applied to the PN-recorrelated matrix. The result of such additional recorrelation is a PN-and-Walsh-recorrelated matrix corresponding to that non-reference transmitter. In an alternate embodiment where there are not distinct pilot-signal and data-signal covers, step 212 may be omitted, and the matrix generated in step 208 may be equalized to estimate the data signal.

At step 214, the equalization weights generated at step 210 are applied to the matrix

$${X}_{M {T}_{2} \times N}$$

and the various PN-and-Walsh-recorrelated matrices to generate an estimate of the transmitted data signal. As the remaining estimated signal is still covered using the cover of the reference transmitter, the signal generated at step 214 must then be decovered at step 216 in order to recover the data.

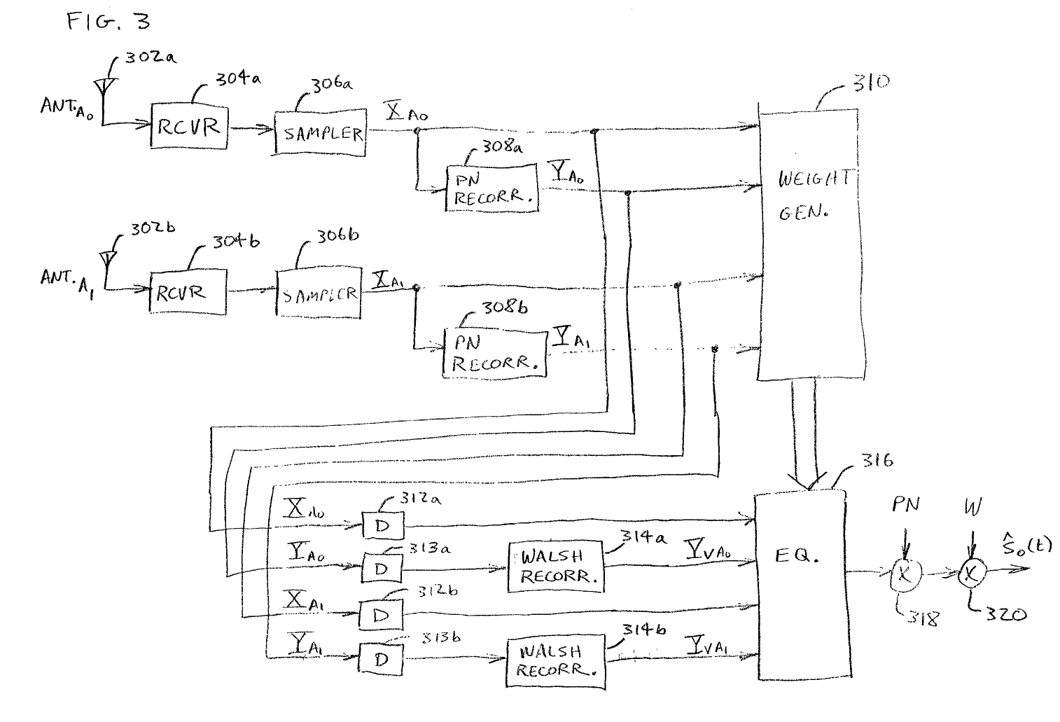

FIG. 3 is a block diagram of a receiver that utilizes S-C-T equalization as described above. Though the receiver is shown with only two receive antennas (M=2), one of skill in the art will recognize that the figure can easily be extended to a larger number of receive antennas or even a single antenna. Where the apparatus of FIG. 3 is modified to accommodate a receiver with a single antenna, the equalizer becomes a cover-time (C-T) equalizer. For each antenna 302, the received signal is gain-adjusted and downconverted in a downconverter/receiver (DCVT) 304 and sampled in a sampler 306. As discussed above, each sampler 306 may be a real sampler or a complex sampler, generating either a real sample stream or a complex sample stream respectively. Each sampler 306 generates an T₂×N matrix of samples X, which is a single-antenna subset of the array

$${X}_{M {T}_{2} \times N}$$

described in EQN. (3) above, wherein each row of the matrix X is an array of consecutive samples. In an exemplary embodiment, each row of X is time-offset by one sample from the rows immediately above and below it. In an alternate embodiment, the rows of X may be time-offset by a constant number of samples greater than one.

In soft handoff, each of several transmitters covers a data signal before transmitting the signal to a receiver. The cover used by one transmitter to transmit a signal to the receiver is different from the cover used by another transmitter to transmit a signal to the same receiver. A receiver in soft handoff uses the different covers to distinguish the signals received from the different transmitters. In an exemplary embodiment, the receiver chooses a single transmitter to be the reference transmitter, and thus identifies a single reference cover. An S-C-T equalizer uses combinations of covers to recorrelate signals received from transmitters other than the reference transmitter. Each signal received from a transmitter other than the reference transmitter is recorrelated using a combination of the reference cover and the cover of the non-reference transmitter.

For each matrix X, a PN recorrelator 308 performs PN recorrelation to generate Y, which is a single-antenna subset of

$${Y}_{M {T}_{2} \times N}$$

according to EQN. (9a), where G_{U}=P_{U}. The PN recorrelator 308 recorrelates the pilot received from a non-reference transmitter to the reference PN cover using a non-reference PN cover and a reference PN cover. The resulting matrices X and Y are used as inputs to a minimum mean square error (MMSE) weight generator 310. In an alternate embodiment, the weight generator 310 performs some type of combining other than MMSE, such as equal gain combining, maximal ratio (MRC), least squares (LS), maximum likelihood (ML), recursive least squares, least mean squares combining. The weight generator 310 generates weights or a matrix of filter coefficients to be used by an equalizer 316.

The exemplary receiver shown in FIG. 3 is designed to receive signals containing pilot channels, such as an IS-95 or cdma2000 forward link. The pilot channel signal in such systems is transmitted as one of multiple orthogonal Walsh channels, each distinguished by a different Walsh code, and all of the channels transmitted by a single transmitter are covered with a pseudonoise (PN) code having a distinguishable PN offset. In IS-95 and cdma2000, pilot channels are transmitted using the all-ones Walsh code. Therefore, after a received signal is decovered using the proper PN code and offset, the channel can be estimated using the pilot code without the need for Walsh de-covering. In the receiver shown in FIG. 3, a signal received from a non-reference transmitter needs only to be recorrelated with the signal from the reference transmitter using PN codes, not Walsh codes. Thus, as shown, the signal received from an antenna needs only to be recorrelated using a PN recorrelator 308 which does not perform any Walsh recorrelating. In an alternate embodiment where some other type of cover than PN or Walsh covers is used, PN recorrelator 308 is replaced with the appropriate type of recorrelator.

In an exemplary embodiment, each PN recorrelator 308 performs recorrelation based on a target PN offset that is centered with respect to the multipath signals being received from all transmitters, reference and non-reference. In this way, the T₂ dimension of the X and Y matrices can be practically minimized, saving memory in a hardware implementation.

In addition to constituting inputs to the weight generator 310, the matrices X and Y are also delayed in delays 312 and 313 to produce delayed versions of those matrices. The delayed version of each X matrix is provided to the equalizer 316. The delayed version of each Y matrix is provided to a Walsh recorrelator 314, which generates a Walsh-recorrelated matrix Y_{V}. Y_{V} is a single-antenna subset of the matrix

$${{Y}_{v}}_{M \cdot {T}_{2} \times N}$$

described in EQN. (9b). The receiver could alternatively be constructed with each delay 313 interposed between the Walsh recorrelator 314 and the equalizer 316.

Delays 312 and 313 compensate for any computational delays introduced by weight generator 310 and Walsh recorrelators 314 such that the weights generated by weight generator 310 can be provided to equalizer 316 in time to be applied to the X and Y_{V} matrices. Equalizer 316 equalizes the multiple recorrelated sample matrices and generates a single estimate of the data transmitted by the reference transmitter. Through the recorrelation in the cover domain effected by PN recorrelators 308 and Walsh recorrelators 314, the equalizer constructively equalizes the signals received from multiple transmitters and transmitted using different covers. The data within the output of equalizer 316 is still covered by the reference cover, including both a PN reference cover and a Walsh reference cover. The output signal of equalizer 316 is then PN de-covered in mixer 318 and Walsh de-covered in mixer 320, resulting in an estimate of the data signal sent by all the transmitters to the receiver. Mixers 318 and 320 may be placed in any order or combined without departing from the exemplary embodiment shown. Also, the mixers 318 and 320 could instead be placed before the equalizer 316.

Where the receiver has more than two antennas, the system of FIG. 3 has an additional instance of downconverter/receiver 304, sampler 306, PN recorrelator 308, delays 312 and 313, and Walsh recorrelator 314 for each additional antenna. Furthermore, the receiver shown in FIG. 3 can equalize signals received from as many as two transmitters, but can be easily extended to receive signals from a larger number of transmitters. Specifically, for each transmitter above two, an additional PN recorrelator 308 and delay 313, and Walsh recorrelator 314 is added for each of the antennas.

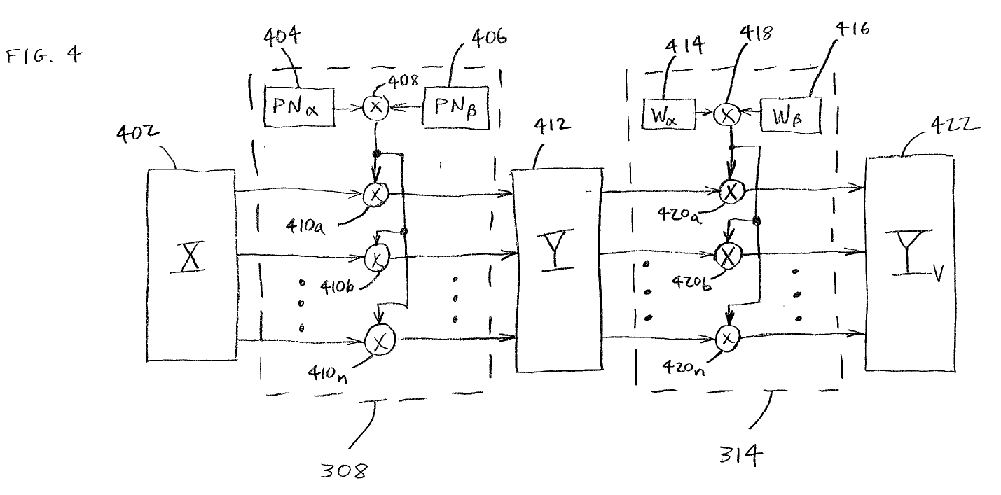

FIG. 4 is an exemplary diagram of a PN recorrelator 308 and a Walsh recorrelator 314. Array 402 contains a T₂×N matrix of samples for a single antenna referred to above as X, As discussed above, each of the T₂ rows of the matrix X is an array of consecutive samples. Each row of X is time-offset by one sample from the rows immediately above and below it. Each of the T₂ rows of X is provided to one of T₂ mixers 410a to 410n. The mixers 410a to 410n mix the consecutive samples in each corresponding row of X with a mixing signal representing the recorrelation cover. The recorrelation cover is generated by mixing the reference PN cover (PN_{α}) generated by a reference PN generator 404 with the PN cover (PN_{β}) corresponding to a non-reference transmitter. The non-reference PN cover (PN_{β}) is generated by a corresponding non-reference PN generator 406. The mixing of the non-reference PN cover with the reference PN cover takes place in a mixer 408. Where the non-reference PN cover is merely an offset version of the reference PN cover, PN generators 404 and 406 and mixer 408 can be replaced by a single PN generator. Such an embodiment capitalizes on the property of PN sequences that the product of two offsets of the same PN sequence generate merely a third offset of the same PN sequence.

The recorrelation cover generated in mixer 408 is provided as a mixing signal to each of the mixers 410a to 41 On. The output of each of the mixers 410 becomes a row of matrix Y stored in array 412.

Walsh recorrelator 314 recorrelates the matrix Y to facilitate equalization of the Walsh-covered data received from a non-reference transmitter. Each of the T₂ rows of Y is provided to one of T₂ mixers 420a to 420n. The mixers 420a to 420n mix the consecutive samples in each corresponding row of Y with a mixing signal representing the Walsh recorrelation cover. The Walsh recorrelation cover is generated by mixing the reference Walsh cover (W_{α}) generated by a reference Walsh generator 414 with the Walsh cover (W_{β}) corresponding to a non-reference transmitter. The non-reference Walsh cover (W_{β}) is generated by a corresponding non-reference Walsh generator 416. The mixing of the non-reference Walsh cover with the reference Walsh cover takes place in a mixer 418. In an alternate embodiment, Walsh generators 414 and 416 and mixer 418 are replaced by a single Walsh recorrelation cover generator.

The Walsh recorrelation cover generated in mixer 418 is provided as a mixing signal to each of the mixers 420a to 420n. The output of each of the mixers 420 becomes a row of matrix Y_{V} stored in array 422.

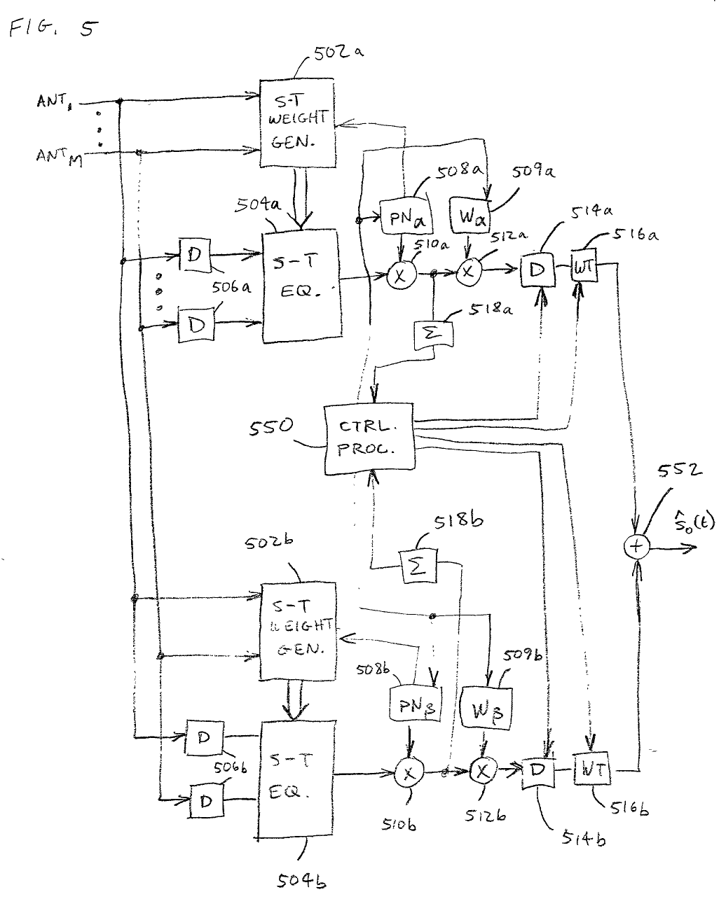

FIG. 5 is a diagram of an alternate embodiment of a S-C-T receiver utilizing S-T equalizers. The embodiment shown performs equalization for signals received from two transmitters, but can be easily extended to receive signals from more than two transmitters.

In an exemplary embodiment as in FIG. 3, each signal is received through a different receive antenna (302 of FIG. 3) is gain-adjusted and downconverted in a downconverter/receiver (304 of FIG. 3) and sampled in a sampler (306 in FIG. 3) to generate a T₂×N matrix of samples X, as described in FIG. 3.

For each transmitter from which the receiver is receiving a soft-handoff signal, the receiver performs separate S-T equalization. Therefore, in an embodiment as shown in FIG. 5, there is not necessarily a single reference transmitter. The signals received from the multiple transmitters are treated identically. In FIG. 5, the elements corresponding to a particular transmitter share the same subscript “a” or “b”. The apparatus shown in FIG. 5 can be readily extended to equalize signals received from more than two transmitters by adding additional sets of elements sharing another subscript. For example, where signals are received from a third transmitter, an additional set of elements sharing the subscript “c” would be added, and so on. An S-T weight generator 502 corresponding to a particular transmitter receives the samples received through every antenna. In an exemplary embodiment, these samples are formed into an array

$${X}_{M {T}_{2} \times N}$$

as described in EQN. (3). The S-T weight generator 502 also receives a signal containing the PN cover corresponding to the particular transmitter from a PN generator 508. Using the received array of samples and the PN cover signal, the S-T weight generator 502 generates equalization weights and provides them to an S-T equalizer 504. In order to compensate for the computational delays associated with generating S-T weights in the S-T weight generator 502, the array

$${X}_{M \cdot {T}_{2} \times N}$$

is delayed using delays 506 before being provided to the S-T equalizer 504. Thus, the S-T equalizer 504 receives the S-T equalization weights from the S-T weight generator 502 in time to apply those equalization weights to the array

$${X}_{M \cdot {T}_{2} \times N} .$$

The output of the S-T equalizer 504 is a single sample stream containing an estimate of the signal transmitted by the corresponding transmitter. Before the data signal can be decoded, the data signal must first be de-covered using the PN and Walsh covers used by the corresponding transmitter. This de-covering is accomplished by mixing the output of the S-T equalizer 504 with a PN cover and a Walsh cover in mixers 510 and 512 respectively. The PN cover and Walsh cover are generated in a PN cover generator 508 and a Walsh cover generator 509 respectively. In an exemplary embodiment, the PN cover provided to the S-T weight generator 502 is centered between all the multipaths being received from the corresponding transmitter. This centering minimizes the time T₂ over which the S-T weight generator 502 must evaluate sample matrices.

In an exemplary embodiment, an estimate of the de-covered data signal estimate for each transmitter is output by a corresponding mixer 512. Because the PN and Walsh covers have been removed from such signals, they can be time-aligned using delays 514 and then constructively added together in a summer 552 to produce a combined data signal estimate for all transmitters.

Depending on signal strength and propagation environment, the reliability and quality of the data signal estimates may be different for different corresponding transmitters. In order to further optimize the combined data signal estimate output by summer 552, the summer input signals are weighted according to quality and reliability. Each delayed data signal estimate output by a delay 514 is weighed in a weighting block 516 before the delayed data signal estimate is provided to the summer 552.

In an exemplary embodiment, a control processor 550 provides timing to each PN cover generator 508 and Walsh cover generator 509. The control processor 550 also provides a control signal to each data signal estimate delay 514 based on the knowledge of the timing of cover generators 508 and 509.

In an exemplary embodiment, the control processor 550 also provides the weight used by each weighting block 516. The control processor 550 bases the weight provided to weighting block 516 on characteristics of the signal output by the S-T equalizer 504. In exemplary embodiment, the PN-decovered output of mixer 510 is integrated in an integrator 518, and the output of the integrator is used by the control processor 550 to generate the weight used by weighting block 516. The control processor 550 generates the weights using any of a number of approaches including MMSE, equal gain combining, maximal ratio (MRC), least squares (LS), maximum likelihood (ML), recursive least squares, least mean squares combining.

In an exemplary embodiment, the integration period of integrator 518 is equal to a the period N described above, and the integrator acts as a low-pass filter for the pilot channel signal. The control processor 550 time-aligns the weight provided to weighting block 516 such that it remains constant over the period N described above. In an alternate embodiment, the output of integrator 518 is provided directly to weighting block 516. This latter embodiment precludes the control processor 550 from directly manipulating the weights applied to the signals received from the various transmitters.

Those of skill in the art would understand that, where combining is necessary, the combining may be accomplished using any of a number of approaches including MMSE, equal gain combining, maximal ratio (MRC), least squares (LS), maximum likelihood (ML), recursive least squares, least mean squares combining.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC within the receiver. In the alternative, the processor and the storage medium may reside as discrete components in a receiver.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A receiver for receiving a data signal from a reference transmitter and a non-reference transmitter, wherein the reference transmitter covers the transmitted data signal using a reference cover and the non-reference transmitter covers the transmitted data signal using a non-reference cover, the receiver comprising:
at least one antenna, for receiving the data signal;
for each of said at least one antenna, a sampler for sampling the data signal received through the corresponding antenna and producing received samples;
a recorrelator for recorrelating said received samples using the non-reference cover and the reference cover to produce recorrelated samples; and
a cover equalizer for performing cover equalization using said received samples and said recorrelated samples.

2. A method for receiving a data signal from a reference transmitter and a non-reference transmitter, wherein the reference transmitter covers the transmitted data signal using a reference cover and the non-reference transmitter covers the transmitted data signal using a non-reference cover, the method comprising:
receiving the data signal through at least one antenna;
sampling the data signal received through each of said at least one antenna to produce received samples;
recorrelating said received samples using the non-reference cover and the reference cover to produce recorrelated samples; and
performing cover equalization using said received samples and said recorrelated samples.

3. A computer readable media embodying a method for receiving a data signal from a reference transmitter and a non-reference transmitter, wherein the reference transmitter covers the transmitted data signal using a reference cover and the non-reference transmitter covers the transmitted data signal using a non-reference cover, the method comprising:
receiving the data signal through at least one antenna;
sampling the data signal received through each of said at least one antenna to produce received samples;
recorrelating said received samples using the non-reference cover and the reference cover to produce recorrelated samples; and
performing cover equalization using said received samples and said recorrelated samples.

4. A remote station apparatus comprising:
means for receiving the data signal through at least one antenna;
means for sampling the data signal received through each of said at least one antenna to produce received samples;
means for recorrelating said received samples using the non-reference cover and the reference cover to produce recorrelated samples; and
means for performing cover equalization using said received samples and said recorrelated samples.
